(19) United States
(12) Patent Application Publication
(10) Pub. No.: US 2026/0009693 A1
(43) Pub. Date: Jan. 8, 2026

(54) Battery Housing and Method for Testing Leak Tightness

(71) Applicant: Mercedes-Benz Group AG, Stuttgart (DE)

(72) Inventors: Christian STASCH, Herrenberg (DE); Michael LUTTMER, Burbach (DE); Philipp SCHUH, Rottenburg (DE); Holger BOMMER, Esslingen (DE); Thorsten HAEFNER, Nuertingen (DE); Timothy NEBELSIEK, Goeppingen (DE)

(21) Appl. No.: 18/881,186

(22) PCT Filed: Jun. 29, 2023
(86) PCT No.: PCT/EP2023/067907

§ 371 Date: Jan. 3, 2025

(30) Foreign Application Priority Data
Jul. 4, 2022 (DE) 10 2022 002 420.9

(51) Int. Cl. G01M 3/26; H01M 10/42

(52) U.S. Cl. CPC G01M 3/26; H01M 10/4228; H01M 10/4285; H01M 2220/20

(57) ABSTRACT

A battery housing for a traction battery includes a first housing part and a second housing part that enclose an internal volume, a connecting element that connects the first housing part to the second housing part in a region of an interface, and a sealing element that seals the interface. A test volume is formed in a region of the interface where the test volume is sealed off from both the internal volume and a surrounding by the sealing element and where the test volume has a test connection. An electrically conductive elastic element permeable to gases is disposed in the test volume where in an unloaded state, the electrically conductive elastic element has a width transverse to an extension direction of the test volume which is greater than an extent of a cross-section of the test volume in the extension direction.

### BACKGROUND AND SUMMARY OF THE INVENTION

The invention relates to a battery housing for a traction battery. Furthermore, the invention relates to a method for testing the leak tightness of an assembled battery housing.

Traction batteries for vehicles, which provide electric drive power for the at least partially electrically driven vehicle, are already known from the prior art. Typically, such traction batteries are constructed from one or more battery modules, which are accommodated in a battery housing or traction battery housing.

In order to be able to produce the battery and also maintain it as needed, several housing parts are always installed in the battery housing, typically at least two housing parts, specifically a lower part accommodating the battery modules and a cover sealing the housing. Interfaces are then formed between these housing parts which comprise, for example, flange surfaces, screw head supports etc. On the one hand these must be sealed against moisture penetration and potentially leaking gases, so that the leak tightness of the housing interfaces is particularly relevant in terms of safety. The housing interfaces typically have sealing elements for this purpose.

When producing the battery with the battery housing or when maintaining the battery in the battery housing, it has to be ensured that this is reliably sealed after successful production or maintenance. This typically takes place by checking the interfaces.

In general, it is known for testing the leak tightness of components to put them under excess pressure and observe how the pressure changes over time. If the pressure decreases in the closed volume, there is a leak. DE 40 34 106 A1 describes such a process for starter batteries.

Such a leak tightness test is, however, unsuitable in practical use for the housing of traction batteries since the battery can only be loaded with a relatively low excess pressure of typically only 50 mbar for technical reasons. Therefore, the detection of a fall in pressure in a time frame reasonable for the production and maintenance is not possible.

In practice, therefore, a test gas, for example helium, is frequently introduced into the assembled and sealed battery housing under such a low excess pressure that is harmless for the battery. Subsequently, the interfaces are scanned with a test gas detector having a sniffer probe in order to detect safety-relevant leaks at the interfaces of the battery housing. This is comparatively complex and although it can be implemented during production, it represents a considerable effort when retesting the leak tightness after maintenance of the battery, during which the battery housing was opened.

A further problem with the battery housings of this type is that both the housing lower part as well as the housing upper part are typically formed as metallic trays or are electrically conductive in another way or are electrically conductively coated. A connection between these two parts of the housing thus also serves to shield electromagnetic fields in that these components form a Faraday cage. Therefore, it is important that these components are connected to each other in an electrically conductive manner. This is frequently achieved by screwing the components together. However, modern manufacturing processes are increasingly focussing on merely adhesively bonding the housing parts of the battery housing, so that additional measures are necessary for the electrical contact between the housing parts, which cause a corresponding amount of effort during assembly with regard to the required components and installation space.

A battery housing for a motor vehicle battery is known from DE 10 2020 107 043 A1. This battery housing comprises two housing parts and, in the interface between these housing parts, an inner seal, which is arranged between the interior of the housing and a screw connection, and an outer seal spaced apart therefrom, which is arranged between the outer region of the housing and the screw connections. Furthermore, tabs are described which enable an electrical contact between the housing parts when connecting same.

The object of the present invention is to specify an improved battery housing which avoids these disadvantages and enables simple and efficient leak tightness testing with a simple electrical contact. Furthermore, the object of the present invention is to specify a method for testing the leak tightness of such a battery.

The battery housing according to the invention provides an at least two-part housing having an interface between the housing parts. The housing parts are connected to each other by sealant and/or adhesive. Sealing elements for sealing the interface, i.e., for sealing off the internal volume of the battery housing from the external surroundings, are arranged in the region of the interface. According to the invention, at least one test volume which is sealed off from both the internal volume as well as the surroundings by the sealing elements and which has at least one test connection is formed in the region of the interface. A test volume is therefore provided which is sealed off from both the interior and also from the surroundings by the sealing elements. This test volume can then be used to pressurize it. A comparatively high excess pressure can be applied in the region of the test volume, as this does not reach the internal volume of the battery housing and the components installed there, nor the surroundings, provided that everything is sealed. Since the test volume is in the region of the interface, its total volume is a lot smaller than the internal volume of the battery. The higher pressure applied can therefore not lead to technical damage to the battery, even if there is a leak inside the battery.

The test volume can be pressurized now with a comparatively high pressure and a conventional testing medium, for example, compressed air. Any fall in pressure in the case of a leak can be detected relatively simply and very quickly because of the higher pressure, so that it is possible to efficiently test the leak tightness of this test volume. Since the test volume of the sealing elements is sealed off from both the internal volume of the battery housing and from the surroundings, both the tightness with respect to the internal volume of the battery housing and with respect to the surroundings can be determined by this test volume enclosed in the interface region when there is no unexpected fall in the pressure. Thus, the leak tightness of the entire interface can be tested and verified very simply and efficiently by the test volume. This is therefore possible in nearly any workshop, as no special equipment is necessary, and as the test can take place quickly and conclusively due to the higher pressures that can be used in the region of the test volume.

In order to guarantee the electrical contact between the two housing parts, it is also provided that an electrically conductive elastic element permeable to gases is introduced into the test volume. This is dimensioned such that in its unloaded state it has a width transverse to the extension direction of the test volume which is greater than the extent of the cross-section of the test volume in this direction. The electrically conductive elastic element therefore fills the test volume completely and projects beyond it at least minimally so that it comes into contact with both one and the other housing part when the housing parts are placed on top of each other and connected, for example by adhesive bonding by means of an adhesive forming the sealing element, and is elastically deformed in the process. It reliably contacts both housing parts due to its elasticity and resilience and connects these to each other electrically.

The elastic electrically conductive element can be formed, for example, as a tube made of metal braid or also as a spiral made of wire, as a spiral spring or as a different structure for example made of wire or metal mesh. This can be easily permeated by a test gas, such as for example compressed air, it is sufficiently elastically deformable in order to not obstruct the sealing of the housing parts, and simultaneously ensures a reliable contact on both housing parts, preferably over a great length in the extension direction of the test volume, in order to ensure secure electrical contacting of the housing parts. Therefore, electromagnetic compatibility (EMC) requirements can be ideally fulfilled.

According to a very favorable embodiment of the battery housing according to the invention, the interface can be formed circumferentially around internal volume. According to a particularly advantageous embodiment of this further development of the battery housing according to the invention it can then be provided that the test volume is formed as a circumferential test volume which is interrupted by a seal transverse to the circumferential direction. The test volume does not extend completely the circumference, but it is interrupted by a corresponding seal, so that it virtually extends from the seal in one direction around the entire circumference to the opposite side of the seal. In this particularly favorable further development, a respective test connection can then be arranged on both sides adjacent to the seal in the circumferential direction The use of two test connections also enables the function of the test volume to be tested along with the actual leak tightness testing. If gases can pass through this test volume from one test connection to the other, then it is guaranteed that the test volume itself is not blocked. If the test volume extends around the entire circumference, it can be ensured in this way that the entire circumference is also tested, and not just a part of the circumference up to any possible blockage in the circumference, which would mean that the following part would remain untested in practice.

A further very favorable embodiment of the battery housing according to the invention provides that the test volume is formed by two parallel beads strips of a sealant and/or adhesive. Two parallel beads of a sealant and/or adhesive can therefore be applied on a flange which ideally forms the interface between the two housing parts, on the one hand in order to form the test volume and on the other hand to reliably seal off the construction between the two housing parts. The external bead can be a sealant and adhesive, for example, which provides both for the sealing as well as for the mechanical stabilization of the connection, whereas the internal bead, i.e., the bead on the interface side facing towards the internal volume, is formed purely as a sealing bead. If required, the above-mentioned seal can then be inserted between the bead strips as a bead strip extending transversely to the other beads, preferably between the two test connections.

Alternatively, this seal can also be achieved by criss-crossing the two bead strips between the two test connections when the paths of the sealant and/or adhesive are formed accordingly from the same material during the assembly of the battery housing.

According to a very advantageous embodiment of the battery housing according to the invention, as explained above, the electrically conductive elastic element can be formed as a metal mesh, as a wire part or as a spring element. According to a very advantageous further development, the metal mesh can be formed as a tube, as a roll wound transverse to its extension direction or as an element having a U- or S-shaped cross-section with respect to the extension direction. In particular, it is easy and efficient to use a tube consisting of metal mesh or metal braid which is readily available on the market as a standard component. Alternatively, a roll wound transverse to its extension direction could be used, i.e., virtually a metal tube, which is not continuously circumferential in the circumferential direction, but has a parting line in the circumferential direction. The entire circumference of the roll can correspond to the circumference of a metal tube, however even more material can be used so that the roll extends around more than once in the circumferential direction. In this case, only a slight overlap of the two ends in the circumferential direction can be provided. Alternatively, a correspondingly shaped metal mesh can be used which is pre-shaped into a U-shape or S-shape, for example, and is inserted into the test volume.

Along with the use of such a metal meshes, which could also be referred to as knitted wire meshes or braids, the use of wire parts is also conceivable, which only consist of bent wire and are formed for example as spirals extending in the extension direction, and which has a certain inherent elasticity due to the shape of the spiral. In principle, spring elements would also be conceivable, in particular for example a spiral spring which extends around the entire circumference of the interface and thus guarantees good electrical contact. Other types of spring elements, such as for example spiral springs with protruding ends would also be conceivable, so that these ends would come to lie between the flange planes of the housing parts and be pressed together during assembly due to the elasticity of the spring part, in order to continuously contact the flanges of the interface.

A further very advantageous embodiment provides that the interface is formed by two flanges of the housing parts, i.e., one flange for each housing part. At least one of the flanges can have a groove for receiving the sealing elements and/or the electrically conductive elastic element permeable to gases. As a result, the positioning of the bead strips is facilitated, in particular when used as sealant and/or adhesive in the form of bead strips applied during assembly. A groove for the electrically conductive elastic element permeable to gases can ensure that this also remains in the desired region during assembly, for example in the centre of the test volume between the two sealing elements or bead strips, in order to guarantee reliable functionality. A stable central positioning can prevent the ingress of sealant and/or adhesive between the elastic element and the material of the flange, at least extensively, so that the electrical contact can be achieved simply and reliably without great assembly effort.

The method according to the invention for testing the leak tightness of such a battery housing provides that the test volume is connected directly or via an adapter volume to a pressure source and to a pressure sensor, wherein the pressure curve is evaluated at the pressure sensor. With such an evaluation of the temporal pressure curve at the pressure sensor, the application of pressure can therefore be detected. Then if the system is closed and the temperature remains approximately constant, the pressure should similarly remain constant. In contrast, if it falls significantly, then it must be assumed that the battery housing is not leak tight.

A further very advantageous embodiment of the method according to the invention provides that when using two test connections, the permeability of the test volume is tested by the at least two test connections in advance, i.e., before the actual pressure test and evaluation of the temporal pressure curve. This can be done, for example, by connecting an adaptation volume to both the one test connection and the other test connection. If the pressure source is now connected, initially the first adaptation volume, then the test volume and finally the second adaptation volume is filled. If the pressure sensor is arranged in the second adaptation volume, the permeability of the test volume can already be determined when the pressure increases in the expected way. If this does not happen, despite an open connection to the pressure source, it can be concluded immediately that there is a fault with the test volume, so it is not possible for the test to be reliable. In contrast, if it is possible for the test to reliable, the test takes place analogously to the set-up described above, in which the temporal pressure curve, here then preferably at the second adaptation volume, is evaluated accordingly. After the desired nominal pressure has built up, this curve should remain constant over a certain period of time, as otherwise there is a leak in the test volume and thus in the seal of the battery housing.

The test can preferably be carried out with a test gas, in principle however also with a test liquid.

Further advantageous embodiments of the battery housing according to the invention and of the method result from the exemplary embodiments which are described in more detail below with reference to the figures.

### BRIEF DESCRIPTION OF THE DRAWINGS

FIG. 1 shows a schematic representation of a battery having a battery housing in an embodiment according to the invention;

FIG. 2 shows an enlargement of the section II in FIG. 1 before assembling the battery housing;

FIG. 3 shows an enlargement of the section II in FIG. 1 after assembling the battery housing;

FIG. 4 shows an embodiment of the sealing element and of the test volume according to FIG. 2 in a plan view;

FIG. 5 shows a schematic representation of a first possibility for the pressure test; and

FIG. 6 shows a schematic representation of a further possibility for the pressure test.

### DETAILED DESCRIPTION OF THE DRAWINGS

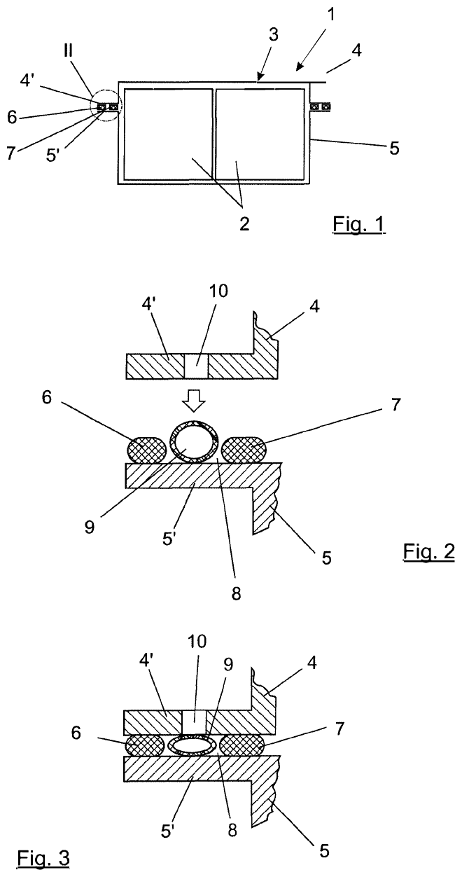

In the representation of FIG. 1, a battery 1 is schematically indicated which is to be formed as a traction battery for providing electric drive power in a vehicle. The battery 1 is formed in this case as a so-called high-voltage battery and typically comprises multiple battery modules, each marked here with 2, which are arranged inside a battery housing 3. The battery housing 3 comprises at least two housing parts 4, 5, which are formed here as a housing lower part 5 and a cover 4. They can be produced as deep-drawn parts from sheet metal, for example. Both housing parts 4, 5 have a flange 4′, 5′ formed at least partially circumferentially around the battery housing 3 in order to connect the housing parts 4, 5 to each other. For example, this can take place by adhesive bonding.

In the enlarged representation of FIG. 2, a possible embodiment is now shown in detail. The two housing parts 4, 5 each form the flange marked with 4′ or 5,′ respectively. An adhesive bead 6 is applied to the outside of the lower flange 5′, i.e., on the side facing away from the internal volume of the battery housing 3, to firmly bond and additionally seal the connection. In addition, another adhesive bead is arranged merely as a sealing element 7 on the side of the flange 5′ facing the internal volume. Both elements 6, 7 can also be swapped over or both can each perform both tasks equally. For simplicity, they are therefore both referred to below as sealing elements 6, 7, although this is not intended to rule out an adhesive effect that is also sufficient for structural load-bearing connections. The sealing elements 6, 7 are preferably generated during assembly by applying a paste-like, preferably elastically curing sealant and adhesive.

A free space remains between the two sealing elements 6, 7, which is to be used later as a test volume 8. An electrically conductive, elastic element 9 permeable to gases is now inserted in the region of this later test volume 8 before the other flange 4′ of the housing upper part 4 is placed on the flange 5′ of the housing lower part 5. This element 9 can be designed in a variety of ways. Particularly preferably, a tube made of a metal braid or metal mesh is used. After the two sealing elements 6, 7 have been mounted on the lower flange 5′ and the electrically conductive elastic and gas-permeable element 9 has been inserted between them in the later test volume 8, the housing upper part 4 is placed on the lower flange with its flange 4′. This placed-on state can be seen in the representation of FIG. 3. The sealing elements 6, 7 connect the two flanges 4′ and 5′ in a sealed manner and bond them to each other in order to close the battery housing 3. Between the sealing elements 6, 7 and the two flanges 4, 5, they enclose the test volume 8 with the electrically conductive, elastic and gas-permeable element 9 arranged therein. As can be seen in the representation in FIG. 3, the element 9 is elastically deformed in the direction of the placed-on upper flange 4, i.e., transverse to the direction in which the test volume 8 extends into the plane of the drawing, and therefore lies securely against both the surface of the flange 5′ and the surface of the flange 4. It thus electrically connects the two housing parts 4, 5 with each other and therefore ensures good shielding from electromagnetic radiation.

In contrast to the representation in FIGS. 2 and 3, grooves for the sealing elements 6, 7 and/or the element 9 could be provided in the flange 5′ and/or the flange 4′ to facilitate their positioning during assembly. Such grooves would be preferably formed in the shape of a circle segment.

In the two representations of FIGS. 2 and 3, a test connection 10 can also be seen in the upper flange 4′, via which the test volume 8 can now be used in an extraordinary way, as described in more detail later, to test the leak tightness of the battery housing 3.

In principle, a single test connection 10 is sufficient to check the test volume 8 around the entire circumference of the battery housing. However, due to the application of the sealing elements 6, 7 as pasty adhesive and/or sealing beads during assembly, the test volume 8 may be interrupted at several points, for example if pasty sealing material gets between the two beads of sealing material 6, 7. This can occur, in particular, when the element 9 is not formed continuously, but has only been inserted into individual sections spread over the circumference, which is possible in principle.

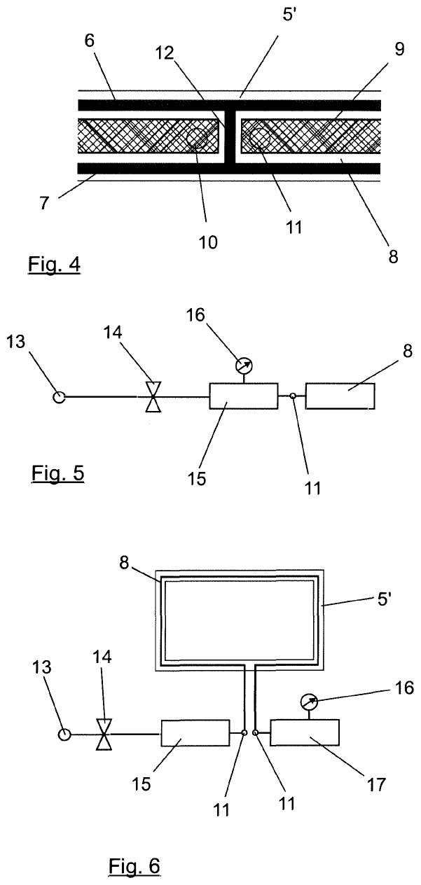

To counter such a fault scenario, two test connections 10, 11 can be provided accordingly. In FIG. 4, a plan view of a section of the flange 5′ analogous to the representation in FIG. 2 is represented. The section of the flange 5′ there has the two test connections 10, 11, which could of course also be arranged in the flange 5′ instead of their arrangement in the flange 4′. In the representation of FIG. 4, the sealing element 6 thus extends at the top, and the sealing element 7 extends at the bottom. The test volume 8 is intended to be circumferential here and is partially filled by a circumferential element 9. A seal 12 is realized between the two test connections 10, 11 from the sealant and adhesive, which seal separates the test volume 8 into a circumferential test volume 8 having two ends facing towards each other. The two test connections 10, 11 are arranged in the region of the respective ends. This allows not only the leak tightness of the test volume 8 or the part of the test volume 8 that is connected to the respective test connection 10, 11 to be tested, but also the passage through the test volume 8 to ensure that it is not blocked by sealant and/or adhesive material which could cause an undetected leak to remain in the area that is not accessible from the respective test connection 10, 11.

A first simple variation of the leak tightness testing is to be described using the schematic representation of FIG. 5. Here, a pressure source 13 is connected via a valve device 14 to an adaptation volume 15, in the region of which a pressure sensor 16 is arranged. The test volume 8 is connected via the test connection 10 in a set-up in which there is only one such test connection 10. By opening the valve 14, first the adaptation volume 15 and then the test volume 8 are filled with the test medium, preferably compressed air. After the valve device 14 is shut off, the pressure determined by the pressure sensor 16 in the test volume 8 connected to the adaptation volume 15 or in the volume formed by these two volumes 8 and 15 should remain constant, provided that the temperature in the surroundings remains constant. If this is the case, then the leak tightness of the test volume 8 and thus ultimately also of the battery housing 3 can be reliably determined, as the test volume 8 is sealed off both from the internal volume of the battery housing 3 and from its surroundings. If there were a leak, the pressure would drop as the test medium would either escape into the internal volume of the battery housing 3 or into the surroundings.

In the representation of FIG. 6, an alternative improved variation of this method is represented. A pressure source 13 and a valve 14 are also used here. A first adaptation volume 15 and a test connection 10 are used to pressurize the test volume 8, which is formed here as a test channel running around one of the flanges 5′, as explained, for example, in the context of FIGS. 4 and 5. A second adaptation volume 17, which has the pressure sensor 16, is then connected via the second test connection 11. When the valve 14 is opened, the first adaptation volume 15 is filled first before the test gas passes through the test volume 8 to the second adaptation volume 17. If there is an increase in pressure at the pressure sensor 16 after the valve 14 is opened, it can be assumed that the test volume 8 can be passed through. If this is arranged as described in FIG. 4, it can thus be ensured that the almost entire circumference of the interface between the two housing parts 4, 5 of the battery housing 3 can be reliably tested. If this is the case, the valve device 14 is closed and the temporal pressure curve is evaluated at the pressure sensor 16. Here, too, a constant pressure over a certain period of time at a constant temperature and ambient conditions is a sign of leak tightness, while a drop in pressure would in turn be a sign of a leak in the area of the interface between the two housing parts 4, 5 or their flanges 4′, 5′.

1.-10. (canceled)

11. A battery housing (3) for a traction battery (1), comprising:
a first housing part (4) and a second housing part (5) that enclose an internal volume;
a connecting element (6) that connects the first housing part (4) to the second housing part (5) in a region of an interface;
a sealing element (7) that seals the interface;
a test volume (8) is formed in a region of the interface, wherein the test volume (8) is sealed off from both the internal volume and a surrounding by the sealing element (7) and wherein the test volume (8) has a first test connection (10); and
an electrically conductive elastic element (9) permeable to gases, wherein the electrically conductive elastic element (9) is disposed in the test volume (8) and wherein in an unloaded state, the electrically conductive elastic element (9) has a width transverse to an extension direction of the test volume (8) which is greater than an extent of a cross-section of the test volume (8) in the extension direction.

12. The battery housing (3) according to claim 11, wherein the interface is formed circumferentially around the internal volume.

13. The battery housing (3) according to claim 12, wherein the test volume (8) is formed as a circumferential test volume (8) which is only interrupted transverse to a circumferential direction by a seal (12), wherein the test volume (8) has a second test connection (11), and wherein the first test connection (10) and the second test connection (11) are disposed on opposing sides of the seal (12) and adjacent to the seal (12) in the circumferential direction.

14. The battery housing (3) according to claim 11, wherein the test volume (8) is formed between two parallel bead strips of a sealant and/or an adhesive.

15. The battery housing (3) according to claim 11, wherein the electrically conductive elastic element (9) is formed from a metal mesh or a metal braid, as a wire part or as a spring element.

16. The battery housing (3) according to claim 11, wherein the electrically conductive elastic element (9) is formed from a metal mesh and wherein the metal mesh is formed as a tube or as a roll wound transverse to an extension direction of the roll or as an element having a U-shaped or S-shaped cross-section.

17. The battery housing (3) according to claim 11, wherein the electrically conductive elastic element (9) is formed from a metal mesh or a metal braid, as a wire part or as a spring element, and wherein the wire part or the spring element has a spiral.

18. The battery housing (3) according to claim 11, wherein the interface is formed by a first flange (4′) of the first housing part (4) and a second flange (5′) of the second housing part (5) and wherein at least one of the first flange (4′) and the second flange (5′) has a groove for receiving the sealing element (7) and/or the electrically conductive elastic element (9).

19. A method for testing a leak tightness of the battery housing (3) according to claim 11, comprising the steps of:
connecting the test volume (8) to a pressure source (13) and a pressure sensor (16) directly or via at least one adaptation volume (15, 17);
pressurizing the test volume (8); and
evaluating a temporal pressure curve at the pressure sensor (16) after the pressurizing.

20. The method according to claim 19, wherein the test volume (8) has a second test connection (11), and further comprising the step of testing a permeability of the test volume (8) between the first test connection (10) and the second test connection (11) before the pressurizing and the evaluating.
